(19) United States
(12) Patent Application Publication
(10) Pub. No.: US 2025/0198870 A1
(43) Pub. Date: Jun. 19, 2025

(54) PRESSURE TRANSDUCER FOR DETERMINING AND/OR MONITORING THE PRESSURE OF A MEDIUM

(71) Applicant: Endress+Hauser SE+Co. KG, Maulburg (DE)

(72) Inventors: Timo Kober, Potsdam (DE); Dietmar Leuthner, Weil am Rhein (DE); Benjamin Mack, Lörrach (DE); Joachim Neuhaus, Steinen (DE); Franz Schneider, Hausen im Wiesental (DE); Sylwester Szymanski, Schopfheim (DE); Jan Lukas Wiemer, Lörrach (DE)

(21) Appl. No.: 18/976,596

(22) Filed: Dec. 11, 2024

(30) Foreign Application Priority Data
Dec. 18, 2023 (DE) 10 2023 135 582.1

(51) Int. Cl. G01L 19/06; G01L 13/02

(52) U.S. Cl. CPC G01L 19/0645; G01L 13/026; G01L 19/0672

(57) ABSTRACT

A pressure measuring transducer for determining and/or monitoring pressure of a medium, comprises a measuring unit and, arranged in the measuring unit, a first pressure sensor which is supplied on a first face with the pressure of the medium and on a second face with a second pressure, and an isolating diaphragm system having a first isolating diaphragm and a second isolating diaphragm which each have an axisymmetric deflection, on which is superimposed a non-axisymmetric, especially antisymmetric, deflection, for achieving a volume change in a pressure chamber.

### CROSS-REFERENCE TO RELATED APPLICATION

The present application is related to and claims the priority benefit of German Patent Application No. 10 2023 135 582.1, filed on Dec. 18, 2023, the entire contents of which are incorporated herein by reference.

### TECHNICAL FIELD

The present disclosure relates to a pressure measuring transducer for determining and/or monitoring a pressure of a medium.

### BACKGROUND

Known in pressure measuring technology are absolute pressure-, pressure difference-and relative pressure measuring transducers. Absolute pressure measuring transducers determine reigning pressure absolutely, i.e. against vacuum, while pressure difference measuring transducers determine the difference between two pressures. In the case of relative pressure measuring transducers, the pressure to be measured is determined with respect to a reference pressure, wherein the atmospheric pressure reigning in the environment of the relative pressure measuring transducer serves as reference pressure, such that so-called gage, or gauge, pressure is measured. A large number of such absolute pressure-, pressure difference-and relative pressure measuring transducers are manufactured and sold by the Endress+Hauser group of companies.

Pressure measuring transducers serve for measuring pressure and/or for controlling and/or automating a process running in a plant. Pressure measuring devices are applied in automation technology in a large number of branches of industry, e.g. in the chemical industry and in the foods industry, to name just a couple of important fields of application. Pressure difference measuring devices serve especially for continuously measuring pressure differences in measured media, e.g. in liquids, vapors and gases. Ascertained from the pressure difference can be, for example, the fill level of a fill substance in a container or the flow of a measured medium through a pipeline.

Pressure- and pressure difference measuring transducers have a pressure sensitive element, a so-called pressure sensor, which is supplied on two opposite faces with, respectively, a first pressure and a second pressure. The pressure of the medium is, in such case, as a rule, not in direct contact with the pressure sensor, but, instead, is registered in the case of a pressure measuring transducer by means of one, and in the case of a pressure difference measuring transducer, by means of two process facing, pressure sensitive, isolating diaphragm(s). Each isolating diaphragm has an isolating diaphragm bed, which serves for embossing its isolating diaphragm and for limiting the displacement of its isolating diaphragm in the case of overload. Frequently, a pressure transfer liquid is supplementally applied, which forwards the pressure of the medium acting on the isolating diaphragm via a pressure transfer path to its one of the two faces of the pressure sensor.

In the case of fracture or damage of an isolating diaphragm, the medium can get into the pressure-, or pressure difference, measuring transducer and contaminate and/or even damage it. In order to prevent this, it is usual in the state of the art to apply an isolating diaphragm system using two isolating diaphragms arranged in parallel with one another, of which one isolating diaphragm faces the medium and the other isolating diaphragm faces the pressure transfer liquid. Between the two isolating diaphragms is an intermediate space in which a vacuum reigns. For such isolating diaphragm systems composed of two isolating diaphragms arranged in parallel with one another, it is usual in the state of the art to use so-called sinusoidal isolating diaphragms. Sinusoidal isolating diaphragms have a concentric, embossed structure, which has cross sectionally the shape of a sine wave.

Disadvantageous in this is that, in using two sinusoidal isolating diaphragms for an isolating diaphragm system, it can occur that, in the case of failure (damage or fracture), the two isolating diaphragms do not release from one another, since, due to their sinusoidal shape and parallel arrangement, they tend to cling to one another.

Further disadvantageous is that special measures are required for evacuation of the intermediate space. For example, a surrounding, ring shaped lumen can be required between the two isolating diaphragms, in order to evacuate air bubbles.

### SUMMARY

An object of the present disclosure is to remedy the above described problems.

The object is achieved according to the present disclosure by the pressure measuring transducer as defined in the claims.

The pressure measuring transducer of the present disclosure for determining and/or monitoring pressure of a medium comprises:
a measuring unit and, arranged in the measuring unit, a first pressure sensor, which is supplied on a first face with the pressure of the medium and on a second face with a second pressure, and
an isolating diaphragm system having a first isolating diaphragm and a second isolating diaphragm, which are arranged relative to one another in such a manner that the first isolating diaphragm faces the medium and the second isolating diaphragm faces away from the medium, and further having between the first isolating diaphragm and the second isolating diaphragm an intermediate space, which is evacuated, such that the intermediate space has a vacuum, wherein the first and second isolating diaphragms are secured on a peripheral edge pressure-tightly to the measuring unit to form a pressure chamber between the second isolating diaphragm and the measuring unit, wherein the pressure of the medium is transferred via the first isolating diaphragm and the second isolating diaphragm to the pressure chamber, wherein the pressure of the medium is transferred via the pressure chamber to the first face of the first pressure sensor, wherein the first and second isolating diaphragms each have a deflectable, especially mutually differing, working range and an embossed contour, wherein the pressure chamber is filled with a reference volume, such that the first and second isolating diaphragms form a reference position, wherein the first and second isolating diaphragms are deflectable from the reference position in two directions, such that the volume of the pressure chamber can be varied, and wherein the first and second isolating diaphragms each have an axisymmetric deflection, on which is superimposed a non-axisymmetric, especially antisymmetric, deflection, for achieving the volume change in the pressure chamber.

According to the present disclosure, use of isolating diaphragms for a double diaphragm system is provided, wherein the isolating diaphragms, for achieving the volume change in the pressure chamber because of the applied media pressure, each execute an axisymmetric deflection, on which a non-axisymmetric deflection is superimposed. This offers the advantage that in the case of failure the two isolating diaphragms release from one another more easily than the in the case of two sinusoidal diaphragms, since then each of the inner-and outer diaphragms strives is to establish its own bending line.

An advantageous embodiment of the pressure measuring transducer of the present disclosure provides that the first and second isolating diaphragms have different thicknesses.

Another advantageous embodiment of the pressure measuring transducer of the present disclosure provides that the first and second isolating diaphragms are formed in such a manner that the intermediate space is evacuable without an annular gap.

### BRIEF DESCRIPTION OF THE DRAWING

The present disclosure will now be explained in greater detail based on the appended drawing, the sole figure of which shows as follows:

FIG. 1 shows a schematic view of a pressure measuring transducer of the present disclosure.

### DETAILED DESCRIPTION

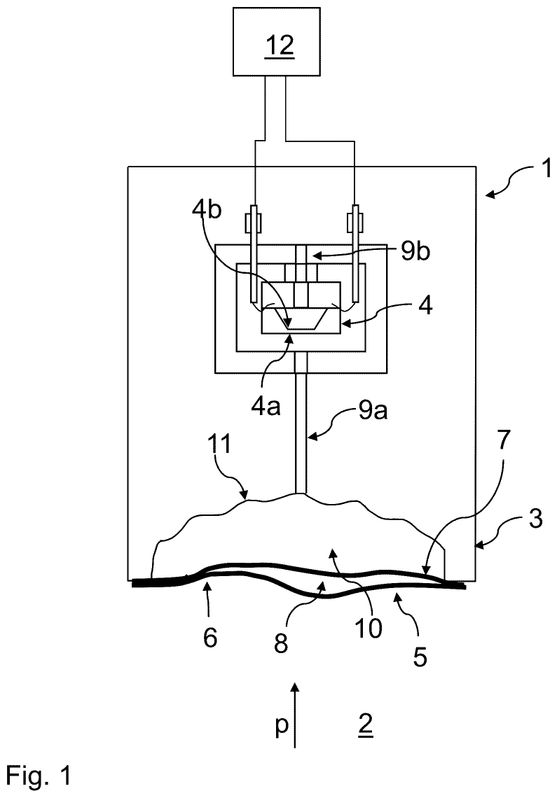

FIG. 1 shows a schematic view of a pressure measuring transducer 1 of the present disclosure serving for determining and/or monitoring a pressure p of a medium 2. An isolating diaphragm system 5 is arranged facing the medium 2. The isolating diaphragm system 5 includes a first isolating diaphragm 6 and a second isolating diaphragm 7, which are connected with a measuring unit 3 pressure-tightly in the edge region. In such case, the first isolating diaphragm 6 faces toward the medium 2 and the second isolating diaphragm 7 faces away from the medium 2. Between the first isolating diaphragm 6 and the second isolating diaphragm 7, the pressure tight connection with the measuring unit encloses an intermediate space 8, in which a vacuum reigns. In the vicinity of the second isolating diaphragm 7, an isolating diaphragm bed 11 can be formed in the measuring unit 3.

The two isolating diaphragms 6, 7 have mutually differing deflectable working ranges and embossed contours and are connected at a peripheral edge with the measuring unit 3 to form a pressure chamber 10. Pressure chamber 10 is filled with a reference volume, such that the first and second isolating diaphragms 6, 7 assume a reference position, out of which the two isolating diaphragms 6, 7 can be deflected in both directions, such that a volume of the pressure chamber 10 can be varied. The first and second isolating diaphragms 6, 7 are formed according to the present disclosure in such a manner that each has, for achieving the volume change in the pressure chamber 10, an axisymmetric deflection, on which a non-axisymmetric, especially antisymmetric, deflection is superimposed. Especially, the first and second isolating diaphragms 6, 7 are formed according to the teachings of EP 2 300 739 B1, to which comprehensive reference is taken. Especially, reference is taken to the contents of paragraphs 25 to 81 of the description of EP 2 300 739 B1.

Via the pressure chamber 10 and a first pressure transfer duct, or-path, 9a, the pressure of the medium 2 is transferred to a first face 4a of a pressure sensor 4 arranged in the measuring unit 3. Pressure sensor 4 is supplied on a second face 4b opposite the first face 4a with a second pressure. The pressure measuring transducer 1 can be embodied as a relative pressure measuring transducer, which transfers an ambient pressure to the second area 4b of the pressure sensor via a second pressure transfer duct, or -path, 9b. Alternatively, the pressure measuring transducer 1 can be embodied as an absolute pressure measuring transducer, wherein the second pressure is then a vacuum. Furthermore, the pressure measuring transducer can also be embodied as a pressure difference measuring transducer, wherein the second pressure is then in contact with the medium in pressure transferring manner likewise via a, preferably embodied equally, isolating diaphragm system.

The measurement signal of the pressure sensor 4 can be transmitted, for example, to an evaluation unit 12, which is embodied, based on the measurement signal of the pressure sensor 4, to determine the pressure p of the medium 2.

1. A pressure measuring transducer for determining and/or monitoring a pressure of a medium, comprising:
a measuring unit and, arranged in the measuring unit, a first pressure sensor, which is supplied on a first face with the pressure of the medium and on a second face with a second pressure; and
an isolating diaphragm system having a first isolating diaphragm and a second isolating diaphragm that are arranged relative to one another such that the first isolating diaphragm faces the medium and the second isolating diaphragm faces away from the medium and further having between the first isolating diaphragm and the second isolating diaphragm an intermediate space that is evacuated such that the intermediate space has a vacuum,
wherein the first and second isolating diaphragms are secured on a peripheral edge pressure-tightly to the measuring unit to form a pressure chamber between the second isolating diaphragm and the measuring unit,
wherein the pressure of the medium is transferred via the first isolating diaphragm and the second isolating diaphragm to the pressure chamber and the pressure of the medium is transferred via the pressure chamber to the first face of the first pressure sensor,
wherein the first and second isolating diaphragms each has a deflectable, mutually differing, working range and an embossed contour,
wherein the pressure chamber is filled with a reference volume such that the first and second isolating diaphragms form a reference position,
wherein the first and second isolating diaphragms are deflectable from the reference position in two directions such that the volume of the pressure chamber can be varied, and
wherein the first and second isolating diaphragms each has an axisymmetric deflection on which is superimposed a non-axisymmetric deflection for achieving the volume change in the pressure chamber.

2. The pressure measuring transducer as claimed in claim 1, wherein the first and second isolating diaphragms have different thicknesses.

3. The pressure measuring transducer as claimed in claim 1, wherein the first and second isolating diaphragms are formed in such a manner that the intermediate space is evacuable without an annular gap.
